(19) United States
(12) Patent Application Publication
(10) Pub. No.: US 2004/0265409 A1
(43) Pub. Date: Dec. 30, 2004

(54) Closed loop oven control system and method

(76) Inventor: Stephen Keeley, Clare, MI (US)

Correspondence Address: John R. Benefiel, Suite 100 B, 280 Daines Street, Birmingham, MI, 48009, US

(21) Appl. No.: 10/851,678

(22) Filed: May 21, 2004

Related U.S. Application Data
(60) Provisional application No. 60/472,220, filed on May 21, 2003.

(51) Int. Cl. B29C 35/00

(52) U.S. Cl. 425/143; 425/110

(57) ABSTRACT

A closed loop control of a heater bank used to preheat sheet plastic in preparation for thermoforming said sheet. The heater bank has zones of the heater bank in which the heaters are variably energized to produce greater heating in some areas of the sheet. A global percent increase in energization of all of the heaters is produced in correspondence to the sensed temperature of a location on the sheet to better control and speed the preheating process.

### CROSS REFERENCE TO RELATED APPLICATIONS

This application claims the benefit of U.S. provisional Ser. No. 60/472,220, filed May 21, 2003.

### BACKGROUND OF THE INVENTION

This invention concerns ovens used to preheat plastic sheet material in preparation for thermoforming the sheets into articles by applying fluid pressure or vacuum to draw the sheets into conformity with the surfaces of molds to be shaped into articles.

These ovens usually have banks of radiant heaters, one bank located above the sheet or sheets and a lower bank below the sheet when in the oven.

In some thermoforming machines cut sheets of plastic are transported in clamping frames which pass through the oven prior to being transported to a forming station where the heated sheet is thermoformed. Multiple sheets are often moved together, as in twin sheet thermoformers.

Other thermoforming machines use a roll of plastic material which is fed into an oven and then into a thermoforming station where the articles are formed. A trim station cuts the articles out of the sheet.

The forming of the parts usually involves a greater extent of bending of the heated sheet in some areas of the sheets. This in turn requires greater heating of these areas in order to create a higher level of plasticity of the sheet in those areas, particularly for heavier sheets such as currently used to form automotive fuel tanks.

This localized variation in heating has been accomplished by a “percent power” control of the individual heaters in the oven banks. In this approach an industrial controller is programmed to turn the heaters on and off in a cyclical fashion, with the percentage of time that the individual heaters are turned on is varied in a zonal pattern which produces greater heating of the sheet areas which is subjected to more severe drawing during thermoforming of the sheet.

The cycle time necessary to reach proper forming temperature is determined empirically so as to insure that when each sheet is transferred into the forming station, it has been properly heated. In many cases, the overall cycle time is determined by the cooling time required after forming. Thus, the sheets will be held in the oven until the forming station is ready to receive another sheet or sheets.

This percent power control has been successfully used in the thermoforming of parts.

However, in some situations the sheets are much colder when introduced into thermoformer apparatus and can vary considerably in their temperature when reaching the oven, as when being stored outside in the winter, and there is a great variation in the time required to reach the proper forming temperature.

This creates a need to increase the rate of heating to reduce the cycle time, and also to include a feedback loop to insure that proper temperature has been reached.

However, due to the varying heating in the different zones, it would be impracticable to create a close loop control over each heater zone, as a large number of zones are often used, i.e., 88 zones in each of an upper and lower heater banks would be typical, and up to 500 zones in each heater bank is possible.

It is the object of the present invention to provide a simplified closed loop control for zonally controlled heater banks used in a thermoforming preheat oven.

### SUMMARY OF THE INVENTION

The above recited object and others which will be understood upon a reading of the following specification and claims are achieved by a closed loop oven control for heating the plastic sheet material in a thermoforming machine. This control uses a single pyrometer mounted approximately aligned with the center of a sheet in position in the oven to generate a signal corresponding to the sensed temperature of the sheet. A “global percent” power factor of the heater zones is derived from the pyrometer signal, preferably by a proportional, integral, derivative (PID) controller. The heater zones are controlled individually on a preset “percent power” basis, with 50% indicating the heaters are “on” half of the fixed time base. For example, for a time base of three seconds and a percent power setting of 66% the heaters in a given zone will be on for two seconds and then off for one second. The global percent is used to add or remove some percentage to all of the heaters in the entire oven bank. For example, if the percent power for a given zone is set for 50% and the global percent is set at 30% then the actual zone power “on” percent is 65% (50+(30/100)×50).

The signal corresponding to the temperature of the material as generated by the pyrometer is used as the input (process variable) to the proportional integral derivative or PID control and the output to the oven bank is the global percent. This is input to a programmable logic controller (PLC) controlling an array of triacs to in turn control energization of the heaters in each zone of each of the heater banks to initially sharply increase the power applied to all of the heaters so as to very quickly and accurately heat up the sheet material to the optimal temperature of the material for thermoforming, and thereafter maintain this temperature by the percent power energization of each heater.

### DESCRIPTION OF THE DRAWINGS

FIG. 1 is a simplified diagrammatic representation of some of the components of a thermoforming apparatus incorporating an oven controlled by the system and method according to the present invention.

FIG. 2 is a diagrammatic representation of a closed loop control system according to the invention for each heater bank.

### DETAILED DESCRIPTION

In the following detailed description, certain specific terminology will be employed for the sake of clarity and a particular embodiment described in accordance with the requirements of 35 USC 112, but it is to be understood that the same is not intended to be limiting and should not be so construed inasmuch as the invention is capable of taking many forms and variations within the scope of the appended claims.

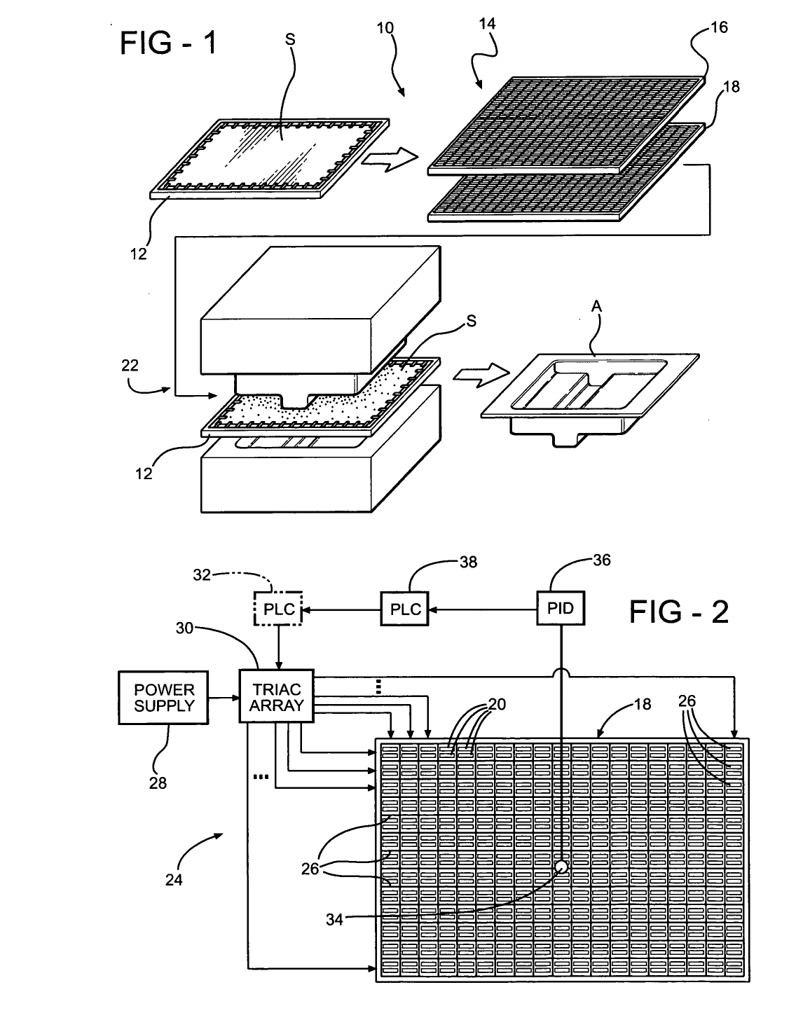

Referring to the drawings, and particularly FIG. 1, a simplified depiction of components of a thermoforming apparatus 10 are shown, which conventionally includes a transfer system (not shown) for moving plastic sheets S previously loaded into clamping frames 12 into an oven 14 comprised of an upper heater bank 16 and a lower heater bank 18. A suitable loading apparatus is shown in copending application Ser. No. 10/654,278, filed on Sep. 2, 2003.

Transfer cars (not shown) may be employed to transfer the clamping frames 12 as is well known in the art. Rotary or linear transfer systems are employed for this purpose.

A rectangular grid array of heaters 20, which typically are quartz radiant heaters, are included in each heater bank 16, 18.

The sheets S are transferred between the heater banks 16, 18 and held there for a period at least sufficient to be heated to the proper temperature for thermoforming. After preheating is complete, and the forming station 22 is ready to receive the next sheet or sheets, the transfer system advances the clamping frame and heated sheet S into a forming station 22 where the sheet or sheets S are molded into an article by a well known thermoforming process. Subsequently, the formed article A is unloaded after a sufficient cooling time.

A suitable thermoforming station is described in copending application Ser. No. 10/218,982, filed on Aug. 14, 2002.

Referring to FIG. 2, a diagram of a control system 24 according to the present invention, is shown associated with the lower heater bank 18, but would also control the upper heater bank 16. The heater banks 16, 18 are each divided into zones 26 which may each include one, two or more individual heaters 20, comprised of quartz radiant heaters.

A power supply 28 is connected to a triac array 30 which controllably connects each of the heaters 20 in each zone 26 to the power supply 28 to allow controlled individual energization of the heater or pair of heaters 20 in each zone 26.

The triac array 30 is in turn connected to a programmable logic controller (PLC) 32 or other type industrial controller which controls turning the individual triacs in the triac array 32 on and off in each zone 26 according to a preset “percent power” program to create varying heating of the zones 26 as determined by an analysis of the degree of heating required for a particular application. This variable heating is accomplished by a suitable programming of the PLC 32 to vary the on and off time of the heaters 20 in each zone 26 over a fixed time base, typically on the order of three seconds. This is known as a “percent power” control scheme. That preset power percentage for each zone 26 is programmed based on an analysis and testing of the particular process.

In order to provide a practical closed loop control, a pyrometer 34 (or other temperature sensor) is arranged to sense the temperature of the plastic sheet at a central location. A central location does not require relocating the pyrometer 34 for sheets of other sizes.

A single pyrometer 34 is indicative of the temperature of the sheet, since normally storage will result in the entire sheet reaching the ambient temperature.

The pyrometer 34 will generate an electrical signal corresponding to the temperature of the sheet S in the preheat oven 14.

This signal is transmitted to a controller 36, preferably a proportional, integral, derivative (PID) controller for rapid action with minimal overshoot.

A set point is selected at the proper thermoforming temperature. A central signal is output from the PID controller 36 which changes the preprogrammed output of the PIC on a “global” basis. That is, a percentage increase is applied to the programmed power percent on-off time set for the heaters in each zone. This global percent changes with the error signal produced by the sensed temperature of the sheet S.

As an example, if in a given heater zone, the heater or heaters are programmed in the PLC 32 to be on 50% of the time in the fixed time base, and the PID controller 36 calls for a 30% global increase, the heater or heaters in that zone 26 will be turned on by additional 15% of the fixed time base, i.e., 30%×50%=15%. This results in a time on of 65%.

Once the proper temperature is reached, the “percent power” continues to operate according to the preset PLC program to maintain the proper heating pattern across the zones.

Thus, a simplified closed loop control is provided even though combined with a percent power control scheme. The cycle time can be changed to meet the necessities of the overall process while insuring proper heating of the sheets.

As shown in FIG. 2, a separate PLC 38 receives the output of the PID controller which sends control signals to the other PLC 32 programmed with the percent power formula so as to change the programmed percent power in the manner described above. However, the PLC 32, 38 may be combined into a single suitably programmer controller.

1. In a thermoforming apparatus including a transfer system for advancing plastic sheets into a preheating oven and thereafter into a forming station, said preheating oven including at least one bank of heaters, with said plastic sheets moved into alignment with said bank of heaters by said transfer system, the improvement comprising a control system for said bank of heaters;
said control system comprising an industrial controller variably energizing heaters in said bank in zones within said bank of heaters so as to create variable heating of areas of said plastic sheet;
a sensor sensing the temperature of one area of said plastic sheets and producing a corresponding signal; and
a global percent control increasing the energization power applied to all of said heaters by said controller by a programmed percent corresponding to the temperature deviation of said plastic sheet from a set point temperature sensed by said sensor, whereby said heaters are controlled by a closed loop control.

2. The apparatus according to claim 1 wherein said global percent control includes a proportional, integral, derivative controller.

3. The apparatus according to claim 2 wherein said industrial controller is programmed to produce a varying percent power “on” of a base time period of heaters in said heater bank.

4. The apparatus according to claim 2 wherein said proportional, integral, derivative controller is connected to a programmable logic controller which in turn is connected to said heaters to control energization thereof.

5. The apparatus according to claim 1 wherein said sensor senses the temperature of said plastic sheet at a central location thereon when in said oven.

6. A method of preheating sheet plastic for forming in a thermoformer apparatus comprising:
arranging a bank of heaters juxtaposed with said sheet plastic;
energizing said heaters variably in different zones of said heater bank to heat said plastic sheet to a varying extent in different areas thereof;
sensing the temperature of said sheet plastic at a particular location thereon;
and changing the variable energization of all of said heaters in correspondence to a deviation of said sensed temperature of said sheet plastic at said location from a set point temperature, whereby a closed loop control of said heater banks is provided.

7. The method according to claim 6 wherein said variable of energization of said heaters in different zones is produced by varying the percentage of time said heaters in different zones are energized in a base time period.

8. The method according to claim 7 wherein said changing of the variable energization of said heaters in correspondence to a deviation in temperature from a set point temperature at a location on said sheet plastic comprises a global percentage corresponding to said temperature deviation.

9. The method according to claim 8 wherein said changing of said variable energization of said heaters is carried out by a proportional, integral derivative controller receiving signals corresponding to said temperature deviation.
